(19) United States
(12) Patent Application Publication
(10) Pub. No.: US 2014/0089468 A1
(43) Pub. Date: Mar. 27, 2014

(54) REQUEST-AGNOSTIC CACHING FOR A DATA RESOURCE COLLECTION

(71) Applicants: Donald JOONG, Montreal (CA); Ganish KATYAL, Saint-Laurent (CA); Sorin Marian Georgescu, Mount Royal (CA)

(72) Inventors: Donald JOONG, Montreal (CA); Ganish KATYAL, Saint-Laurent (CA); Sorin Marian Georgescu, Mount Royal (CA)

(21) Appl. No.: 13/628,953

(22) Filed: Sep. 27, 2012

(51) Int. Cl. G06F 15/16

(52) U.S. Cl. 709/219

(57) ABSTRACT

Embodiments herein include a method performed by an intermediate proxy node via which client devices request data resources from a data resource server. The data resources are organized into different data resource collections. The method includes receiving a request for a subset of a data resource collection and, responsive to receiving such a request, determining that the collection is not stored in a request-agnostic cache maintained by the proxy node. Responsive to this determination, the method further entails retrieving the collection from the data resource server. The method then includes extracting the requested subset from the retrieved data resource collection and selectively returning that subset as a response to the request. Finally, the method entails storing the data resource collection in the request-agnostic cache for serving other requests for data resources in the data resource collection, including a request for a different subset of the data resource collection.

### TECHNICAL FIELD

The present invention generally relates to caching performed by an intermediate proxy node via which client devices request data resources from a data resource server, and particularly relates to caching data resources in a request-agnostic manner.

### BACKGROUND

A proxy node serves as an intermediary between client devices and a data resource server. In this role, the proxy node intercepts requests from client devices for data resources, such as files, services, web pages, data objects, or the like. The proxy node services any given request from a client device by forwarding the request to the data resource server, receiving the response to that request from the data resource server, and then relaying the response to the requesting client device.

Configuring a proxy node to serve as an intermediary in this way proves advantageous when the proxy node caches server responses. In this regard, after the proxy node services a particular request, the proxy node stores the response to that request in a cache on a request-by-request basis (i.e., the cache maps requests to corresponding responses). If the proxy node thereafter receives that same request again, the proxy node quickly returns the response to that request as stored in the cache rather than redundantly forwarding the request to the data resource server. The proxy node thereby accelerates resource requests from the perspective of the client devices, reduces the bandwidth required to forward requests to the data resource server, and reduces processing requirements on the data resource server.

There still remains a need, however, for fully realizing these advantages of proxy node caching in all contexts.

### SUMMARY

Teachings herein advantageously provide efficient proxy node caching in contexts where data resources are organized into different data resource collections. Rather than naively caching data resource server responses on a request-by-request basis, a proxy node herein intelligently caches data resources in a request-agnostic manner. As one example, this enables the proxy node to efficiently respond to a request for a subset of a data resource collection using data resources cached in response to a different request for a different subset of that collection.

More specifically, some embodiments herein include a method performed by an intermediate proxy node via which client devices request data resources from a data resource server. The data resources in these embodiments are organized into different data resource collections. The method includes receiving a request (e.g., an HTTP request) for a subset of a data resource collection and, responsive to receiving such a request, determining that the collection is not stored in a request-agnostic cache maintained by the proxy node. Responsive to this determination, the method further entails retrieving the collection from the data resource server. The method then includes extracting the requested subset from the retrieved data resource collection and selectively returning that subset as a response to the request. Finally, the method entails storing the data resource collection in the request-agnostic cache for serving other requests for data resources in the data resource collection, including a request for a different subset of the data resource collection.

In at least some embodiments, the method also includes receiving a different request for a different subset of the data resource collection. In one embodiment, for example, the request and the different request are received from different types of client devices with at least one of different display, memory, and processing capabilities. Regardless, in this case, the method entails, responsive to receiving this different request, extracting the different subset from the data resource collection stored in the request-agnostic cache and selectively returning the different subset extracted from the data resource collection as a response to the different request.

In one or more embodiments, receiving a request for a subset comprises receiving a request for a data resource collection in conjunction with one or more constraining parameters that constrain a response to the request to the subset. In this case, retrieving the data resource collection from the data resource server comprises sending the request for the data resource collection without the one or more constraining parameters towards the data resource server.

In one such embodiment, selectively returning the subset of the data resource collection as a response to the request thus comprises processing the data resource collection received from the data resource server according to the one or more constraining parameters in order to extract the subset from the data resource collection. This extracted subset is then returned as the response to the request.

One or more alternative embodiments herein include a different method performed by the intermediate proxy node. According to this different method, processing at the proxy node includes receiving a request for a subset of a data resource collection. Processing also includes identifying a first part of the requested subset as being stored in a request-agnostic cache maintained by the intermediate proxy node and a second part of the requested subset as not being stored in the request-agnostic cache. Processing further entails retrieving the first part of the requested subset from the request-agnostic cache and the second part of the requested subset from the data resource server, and then returning the requested subset as formed from the first and second parts retrieved.

In at least some embodiments, before the request for the subset is received, the first part of the subset is retrieved from the data resource server and stored in the request-agnostic cache in response to one or more requests for one or more different subsets. Similarly, in one or more embodiments, the method further involves storing the second part of the requested subset in the request-agnostic cache for serving other requests for data resources in the data resource collection. This includes a request for a different subset of the data resource collection. In one embodiment, receiving the request for the subset comprises receiving a request for the data collection in conjunction with one or more constraining parameters that constrain a response to the request to the subset. In this case, retrieving the second part of the requested subset from the data resource server comprises selectively sending the request for the data resource collection towards the data resource server with those of the constraining parameters that are to constrain a response to the second part of the subset, but without any of the constraining parameters that are to constrain a response to the first part of the subset.

Embodiments herein also include apparatus configured to implement these methods.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of a system that includes an intermediate proxy node configured according to one or more embodiments.

FIG. 2 is a logic flow diagram of a method implemented by an intermediate proxy node according to one or more embodiments.

FIG. 3 is a call flow diagram illustrating call flow processing according to one or more embodiments.

FIG. 4 is a logic flow diagram of a method implemented by an intermediate proxy node according to one or more other embodiments.

FIG. 5 is a call flow diagram illustrating call flow processing according to one or more other embodiments.

FIG. 6 is a block diagram of an intermediate proxy node according to one or more embodiments.

FIG. 7 is a block diagram illustrating functional details associated with the one or more processing circuits of the intermediate proxy node according to one or more embodiments.

### DETAILED DESCRIPTION

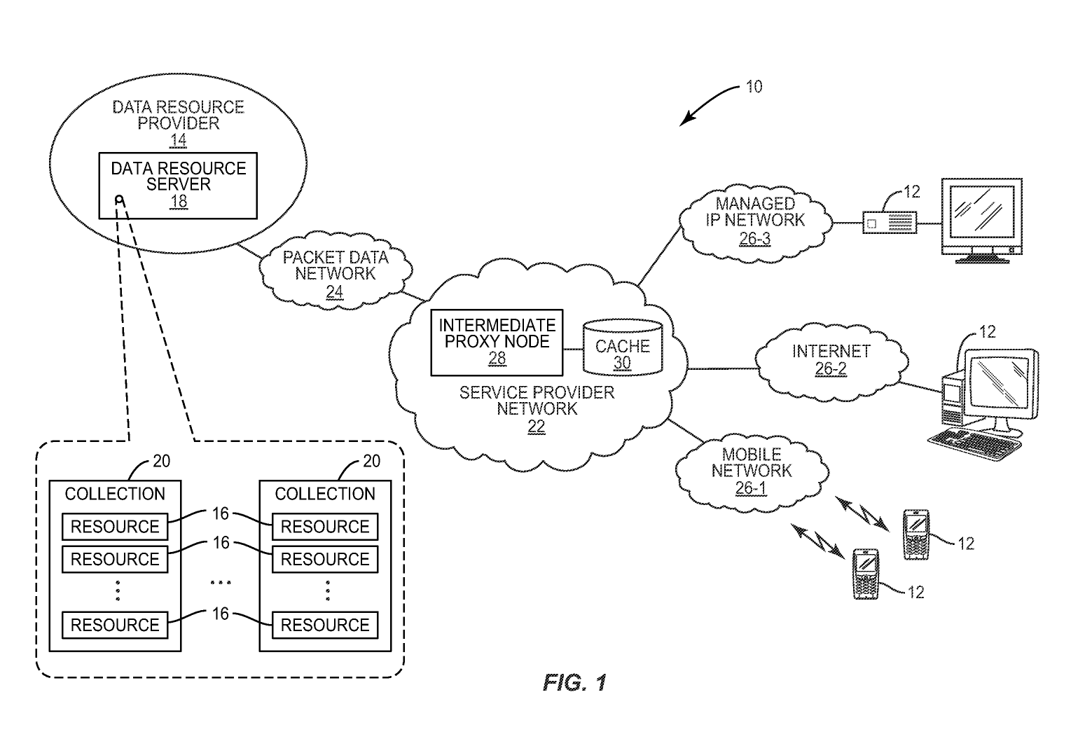

FIG. 1 depicts a data resource delivery system 10 according to one or more embodiments. The system 10 includes one or more client devices 12 that send requests towards a data resource provider 14 for data resources 16, such as files, web pages, data objects, or the like. A data resource server 18 maintained by the resource provider 14 organizes these data resources 16 into different data resource collections 20. In some embodiments, for example, the data resource server 18 organizes data resources 16 into a given collection 20 based on those data resources 16 being associated with a common property, attribute, or characteristic. The server 18 in some embodiments is capable of including any given data resource 16 within one or more collections 20. Regardless, the data resource server 18 delivers requested data resources 16 to a service provider network 22 via a packet data network 24. The service provider network 22 in turn delivers the requested data resources 16 to the one or more client devices 12 over one or more delivery networks 26, such as a mobile communication network 26-1, the Internet 26-2, or a managed Internet Protocol (IP) network 26-3.

The client devices 12 more specifically request data resources 16 from the data resource server 18 via an intermediate proxy node 28. FIG. 1 shows this proxy node 28 as being included in the service provider network 22. The proxy node 28 notably maintains a request-agnostic cache 30 for storing data resources 16 retrieved from the data resource server 18. As used herein, the cache 30 is request-agnostic in the sense that the cache 30 stores data resources 16 independently of the requests for those resources 16.

By intelligently caching data resources 16 in this request-agnostic manner, rather than naively caching data resources as responses to requests, the proxy node 28 advantageously provides caching that is efficient even when client devices 12 request subsets of a data resource collection 20 rather than the entire collection 20. Indeed, in this case, the request-agnostic cache 30 stores any data resources 16 within the collection 20 independently of whether those resources 16 belong to different requested subsets of the collection 20. This enables the proxy node 28 to efficiently respond to a request for a subset of the collection 20 using data resources 16 cached in response to a different request for a different subset of that collection 20. In this sense, then, the cache's storage of data resources 16 in a request-agnostic manner intelligently exploits the resource server's organization of the data resources 16 into different collections 20.

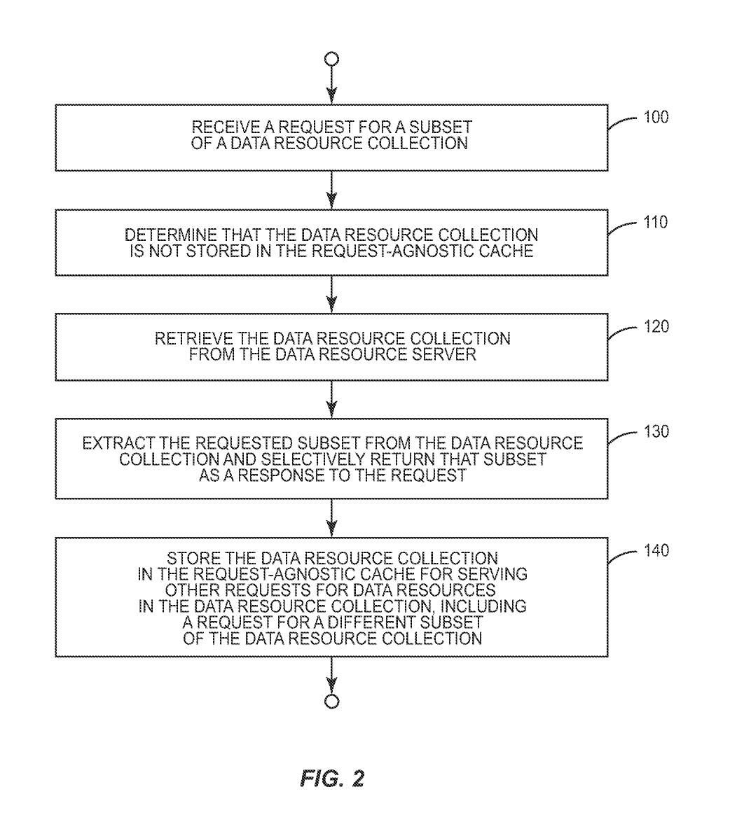

In one or more embodiments of request-agnostic caching, for example, the proxy node 28 proactively caches a data resource collection 20 responsive to a request for a subset of that collection 20. The proxy node 28 does so in anticipation of receiving other requests for other data resources 16 that are not in the requested subset but that are nonetheless in the collection 20. This means that the request-agnostic cache 30 effectively stores data resources 16 on a collection basis rather than on a request basis. FIG. 2 illustrates processing performed by the proxy node 28 according to such embodiments.

As shown in FIG. 2, processing at the proxy node 28 includes receiving a request for a subset of a data resource collection 20 (Block 100). Responsive to receiving this request, processing further includes determining that the data resource collection 20 is not stored in the request-agnostic cache 30 maintained by the proxy node 28 (Block 110). In at least some embodiments, the proxy node 28 determines that the collection 20 is not stored in the request-agnostic cache 30 by determining that the requested subset of the collection 20 is not stored in the cache 30. In other embodiments, though, the proxy node 28 determines that the collection 20 is not stored in the request-agnostic cache 30 by determining that at least one data resource 16 outside the requested subset but included in the collection 20 is not stored in the cache 30.

Regardless, responsive to determining that the collection 20 is not stored in the request-agnostic cache 30, processing at the proxy node 20 entails retrieving the collection 20 from the data resource server 18. That is, even though only a subset of the collection 20 was requested, the proxy node 20 proactively retrieves the complete collection 20. Having retrieved the collection 20 in this way, processing at the proxy node 28 includes extracting the requested subset from the retrieved collection 20 and selectively returning that subset as a response to the request (Block 130). Processing also entails storing the collection 20 in the request-agnostic cache 30 for serving other requests for data resources 16 in the collection 20, including a request for a different subset of the collection 20 (Block 140). In some embodiments, for example, the proxy node 20 caches the collection 20 in anticipation of receiving these other requests in the future, from either the same client device 12 or a different client device 12 than the one that requested the subset.

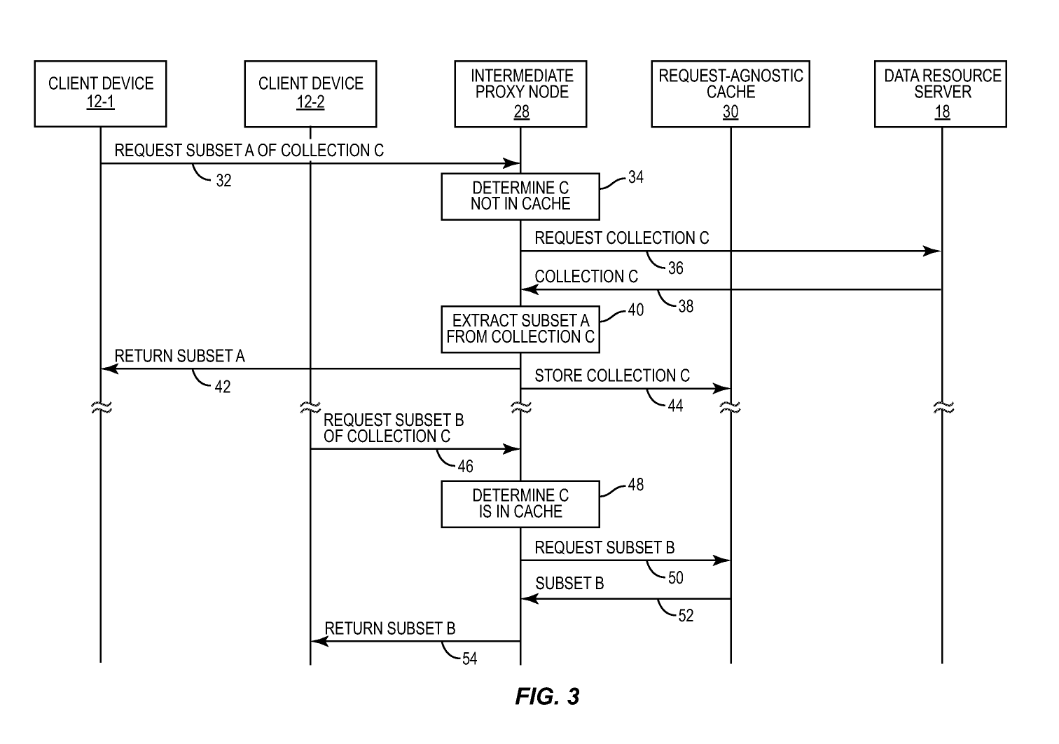

FIG. 3 illustrates one example of embodiments where proactive collection caching proves advantageous for servicing requests from different client devices 12 for different subsets of the same collection 20. As shown in FIG. 3, a first client device 12-1 sends a request (e.g., a Hypertext Transfer Protocol, HTTP, request) to the intermediate proxy node 28 for subset A of a data resource collection C (Step 32). Responsive to this request, the proxy node 28 determines that collection C is not stored in the request-agnostic cache 30 (Step 34). In some embodiments, this determination entails querying the cache 30 (not shown) for whether or not the collection 30 is stored therein. In other embodiments, this determination involves inspecting information maintained at the intermediate proxy node 28 that tracks or otherwise identifies data resources 16 stored in the cache 30. As one example, such information includes a table or other data structure that lists the data resources 16 stored in the cache 30. Regardless, upon determining that the collection C is not stored in the cache 30, the proxy node 28 sends a request to the data resource server 18 for the complete collection C, rather than just for subset A of the collection C (Step 36). The proxy node 28 does so in anticipation of receiving a future request for at least one data resource 16 not included in subset A. Upon receiving collection C in response (Step 38), the proxy node 28 extracts subset A from the received collection C (Step 40) and selectively returns the extracted subset A to client device 12-1 as requested (Step 42). The proxy node 28 also stores the received collection C in the request-agnostic cache 30 (Step 44). Although FIG. 3 shows that the proxy node 28 stores collection C after returning subset A to client device 12-1, the proxy node 28 in other embodiments stores collection C before returning subset A.

In at least some embodiments, the request-agnostic cache 30 stores collection C for a predetermined amount of time. Once this amount of time expires, collection C as stored in the cache 30 is considered “dirty” or “stale” and is therefore discarded from the cache 30. In one or more embodiments, though, a request for one or more data resources 16 in collection C resets the expiration time of collection C as stored in the cache 30.

Regardless, continuing the example of FIG. 3, a second client device 12-2 later sends a request to the intermediate proxy node 28 for subset B of collection C, where subset B differs from subset A. Even though the proxy node 28 has not heretofore received a request for subset B, the proxy node 28 intelligently determines that the request concerns collection C and that collection C has been (and still is) stored in the request-agnostic cache 30 due to having previously received a different request concerning collection C (Step 48). Rather than sending a request to the data resource server 18 for subset B, therefore, the proxy node 28 simply requests and receives subset B from the request-agnostic cache 30 (Steps 50 and 52). Although not shown, the proxy node 28 in other embodiments alternatively requests and receives the complete collection C from the cache 30 and processes collection C in order to retrieve subset B from that collection. In either case, though, the proxy node 28 effectively extracts subset B from the collection C stored in the cache 30. Having extracted subset B in this way, the proxy node 28 selectively returns that subset B to the second client device 12-2 as requested (Step 54).

Note that proactive collection caching as described in FIG. 3 proves advantageous for responding to the request for subset B even if subset B is mutually exclusive of the previously requested subset A. Nonetheless, in some embodiments, at least one data resource 16 in subset B is also included in subset A. In fact, in one such embodiment, subset A is actually a subset of subset B.

Consider an example where the first and second client devices 12-1 and 12-2 are different types of devices, at least in the sense that they have different display, memory, and/or processing capabilities. In one embodiment, for instance, the first client device 12-1 (e.g., as a mobile terminal) has relatively limited display, memory, and/or processing capabilities, while the second client device 12-2 (e.g., as a set-top-box) has relatively expanded display, memory, and/or processing capabilities. Given the greater capabilities of the second client device 12-2, the device 12-2 is configured to request subsets that are larger in size than that of the subsets requested by the first client device 12-1.

In one practical example, the data resources 16 comprise splash images (i.e., “posters”) associated with different videos available for viewing in an IPTV system. The data resource server 18 organizes these images into different collections that correspond to genres of the associated videos. For instance, one collection of images includes those images associated with an “Action/Adventure” genre of videos, while another collection of images includes those images associated with a “Kids” genre of videos, etc. Given the more limited capabilities of the first device 12-1, the device 12-1 at any given time requests a smaller subset of images for presenting the videos available within a given genre, while the second device 12-2 requests a larger subset of images. This means that the first and second devices 12-1, 12-2 will generate different requests for different subsets of images while browsing any given genre of videos. Despite this difference, the proxy node 28 advantageously responds to the second client device's request for a larger subset using the collection of images cached in response to the first client device's request for a smaller subset.

In at least some of these IPTV embodiments, and embodiments applicable in other contexts as well, a client device 12 requests a subset of a data resource collection 20 by sending a request for the collection 20 in conjunction with one or more constraining parameters. These constraining parameters constrain a response to the request to the subset. When the collection 20 is not stored in the request-agnostic cache 30, the proxy node 28 retrieves the collection 20 from the data resource server 18 by sending the request for the collection 20 without the one or more constraining parameters towards the server 18. That is, the proxy node 28 intelligently modifies the request received from the client device 12 so that the request excludes the one or more constraining parameters and then sends that modified request towards the data resource server 18. This way, the proxy node 28 forces the server 18 to naively respond with the complete collection 20, even though unbeknownst to the server 18 the client device 12 only requested a subset of that collection 20.

When the proxy node 28 modifies the request in order to remove the one or more constraining parameters, the proxy node 28 stores those parameters in memory as having been sent in conjunction with the request. Then, responsive to receiving the collection 20 to which the request concerned from the data resource server 18, the proxy node 28 stores the collection 20 in the cache 30 and filters or processes the collection 20 according to the stored constraining parameters in order to extract the requested subset from the collection 20. In some sense, then, the proxy node 28 herein is advantageously equipped with intelligence or logic similar to that at the data resource server 18 for examining, understanding, and processing the constraining parameters sent with a request. Equipped with this intelligence, the proxy node 28 can exploit the server's organization of data resources into collections in order to efficiently cache those resources 16. In any event, upon applying this logic in order to extract the requested subset from the retrieved collection 20, the proxy node 28 returns that extracted subset to the client device 12 as the response to the request. The proxy node 28 handles subsequent requests for different subsets of the collection 20 in an analogous manner; that is, by processing the collection 20 as stored in the cache 30 according to the respective constraining parameters sent in conjunction with those requests.

In one embodiment, for example, the request comprises an HTTP request. In this case, the request is represented by a Uniform Resource Identifier (URI) whose destination address indicates a data resource collection 20 associated with the request and whose HTTP query string indicates the one or more constraining parameters. Consider for instance a URI of http://a.com/example?fetch=C₁,C₂. The destination address “http://a.com/example” represents a request for a data resource collection “example.” The HTTP query string “fetch=C₁,C₂” indicates the one or more constraining parameters. These parameters constrain a response to the request to a subset that includes the resources indexed as “C₁” and “C₂” within the “example” collection.

When the proxy node 28 receives this URI from a client device 12 and the collection “example” is not stored in the cache 30, the proxy node 28 modifies the URI to simply be “http://a.com/example” without the constraining parameters indicated by the HTTP query string. Responsive to sending this modified URI towards the data resource server 18, the proxy node 28 receives and caches the complete “example” collection from the server 18, which may include for instance resources C₁-C₃₀. The proxy node 28 then processes the collection 20 according to the constraining parameters indicated by the HTTP query string in order to extract the “C₁” and “C₂” resources and selectively return those extracted resources to the client device 12.

Consider now an example where the proxy node 28 thereafter receives a different URI of http://a.com/example?fetch=C₁,C₂,C₃,C₄ from the same or a different client device 12. The proxy node 28 in this case recognizes the URI as concerning the “example” collection and determines that this collection 20 has been (and still is) stored in the request-agnostic cache 30. Thus, rather than requesting resources C₁-C₄ from the data resource server 18, the proxy node 28 extracts those resources from the “example” collection stored in the request-agnostic cache 30 and selectively returns those extracted resources.

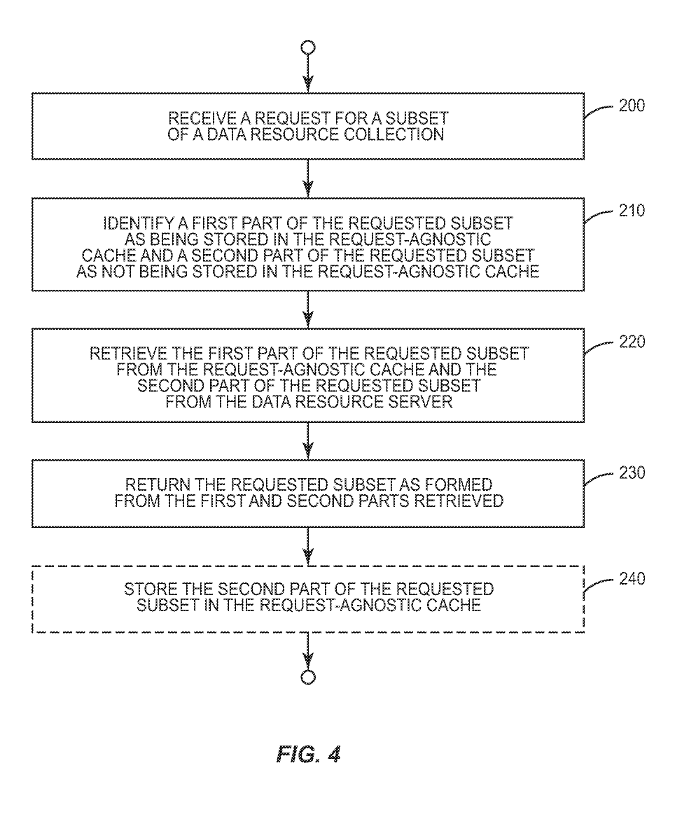

Rather than proactively retrieving resources 16 before they have been requested in order to cache a complete collection 20, as described above, the proxy node 28 in alternative embodiments herein reactively builds such a cache over time based on retrieving resources 16 as they are requested. That is, the request-agnostic cache 30 still generally stores data resources 16 on a collection basis as described above, but any given collection 20 in the cache 30 is populated over time responsive to requests for multiple different subsets of the collection 20 rather than responsive to a single request for any subset of the collection 20. Thus, responsive to any given request, some of the requested data resources 16 may be stored in the request-agnostic cache 30 while other requested data resources 16 may be absent from the cache 30. FIG. 4 illustrates processing performed by the proxy node 28 in this case.

As shown in FIG. 4, processing at the proxy node 28 for this reactive collection caching includes receiving a request for a subset of a data resource collection 20 (Block 200). Processing then entails identifying a first part of the requested subset as being stored in the request-agnostic cache 30 maintained by the proxy node 28 and a second part of the requested subset as not being stored in the cache 30 (Block 210). In some embodiments, for example, this entails evaluating the request to determine which resources 16 are requested, and querying the cache 30 to determine which of those requested resources 16 are stored in the cache 30 and which are not. In any event, processing at the proxy node 28 further entails retrieving the first part of the requested subset from the request-agnostic cache 30 and the second part of the requested subset from the data resource server 18 (Block 220). In this way, the proxy node 28 intelligently involves the data resource server 18 only to the extent needed to retrieve the non-cached resources 16 (i.e., the second part of the subset), without burdening the server 18 to redundantly provide already cached resources 16 (i.e., the first part of the subset). Finally, processing includes returning the requested subset as formed from the first and second parts retrieved (Block 230).

In one or more embodiments, the first part of the requested subset was stored in the request-agnostic cache 30 because the proxy node 28 had previously retrieved those resources 16 from the data resource server 16 in response to one or more requests for one or more different subsets of the collection 20. And, when the proxy node 28 retrieved those resources 16, the node 28 stored them in the request-agnostic cache 30 in anticipation of receiving future requests concerning the collection 20.

In the same manner, therefore, processing at the proxy node 28 in one or more embodiments further entails storing the second part of the requested subset in the request-agnostic cache 30 (Step 240). The proxy node 28 does so in anticipation of serving other requests for data resources 16 in the collection 20, including a request for a different subset of the collection 20.

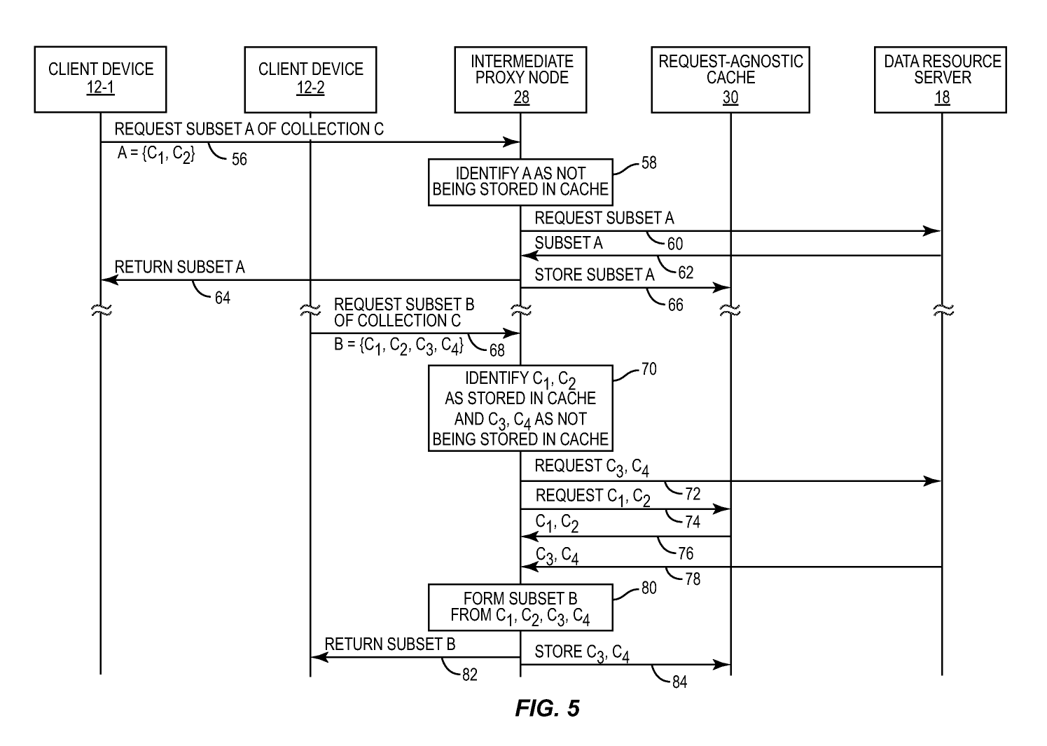

FIG. 5 illustrates one example of embodiments where reactive collection caching proves advantageous for servicing requests from different client devices 12 for different subsets of the same collection 20. As shown in FIG. 5, a first client device 12-1 sends a request (e.g., an HTTP request) to the intermediate proxy node 28 for subset A of a data resource collection C (Step 56). In this example, subset A includes data resources C₁ and C₂, and the collection C includes resources C₁-C₃₀. Responsive to this request, the proxy node 28 identifies that none of the resources in subset A are stored in the cache 30 (Step 58). The proxy node 28 therefore reactively sends a request to the data resource server 18 for subset A of the collection C, as opposed to sending a request for the complete collection C as described above (Step 60). Upon receiving subset A in response (Step 62), the proxy node 28 returns subset A to client device 12-1 as requested (Step 64) and stores subset A in the request-agnostic cache 30 (Step 66). Although FIG. 5 shows that the proxy node 28 stores subset A after returning subset A to client device 12-1, the proxy node 28 in other embodiments stores subset A before returning subset A.

A second client device 12-2 later sends a request to the intermediate proxy node 28 for subset B of collection C (Step 68). Subset B differs from subset A because subset B includes not only data resources C₁ and C₂, but also includes data resources C₃ and C₄. Even though the proxy node 28 has not heretofore received a request for subset B, the proxy node 28 intelligently identifies a first part of subset B (namely, C₁ and C₂) as being stored in the cache 30 and a second part of subset B (namely, C₃ and C₄) as not being stored in the cache 30. Accordingly, rather than sending a request to the data resource server 18 for the complete subset B (or the complete collection C), the proxy node 28 requests and receives just the second part of subset B from the data resource server 18 (Steps 72 and 78). And, after requesting and receiving the first part of subset B from the request-agnostic cache 30 (Steps 74 and 76), the proxy node 28 itself forms subset B from the first and second parts retrieved (Step 80). The proxy node 28 then returns subset B to client device 12-2 (Step 82) and stores the second part of subset B in the cache 30 (Step 84).

Note that, unlike proactive collection caching, reactive collection caching as just described proves advantageous for responding to the request for subset B only if subset B at least partially overlaps with the previously requested subset A (or any other previously requested subsets). But, reactive collection caching proves more efficient than proactive collection caching in circumstances where, in hindsight, not all data resources 16 within a given collection 20 actually needed to be retrieved.

Also note that the proxy node 28 processes a request differently in reactive collection caching embodiments than in proactive collection caching embodiments, particularly when the request for a subset comprises a request for a collection 20 in conjunction with one or more constraining parameters. In this regard, when the proxy node 28 identifies the second part of the requested subset as not being stored in the request-agnostic cache 30, the proxy node 28 retrieves that second part from the data resource server 18 by selectively sending the request for the collection 20 towards the data resource server 18 with those of the constraining parameters that are to constrain a response to the second part of the subset, but without any of the constraining parameters that are to constrain a response to the first part of the subset. That is, the proxy node 28 intelligently modifies the request received from the client device 12 so that the request excludes the one or more constraining parameters associated with the first part, but still includes the one or more constraining parameters associated with the second part. The proxy node 28, for example, would modify an HTTP request for subset B in FIG. 5 from http://a.com/example?fetch=C₁,C₂,C₃,C₄ to http://a.com/example?fetch=C₃,C₄. Regardless, the proxy node 28 then sends that modified request towards the data resource server 18. This way, the proxy node 28 forces the server 18 to naively respond with only the second part of the requested subset, even though unbeknownst to the server 18 the client device 12 actually requested the first part of the subset as well.

Although the above embodiments discussed the request-agnostic cache 30 as if it was the only cache in the system 10, those skilled in the art will appreciate that in other embodiments other caches also store data resources 16. In at least one embodiment, though, the request-agnostic cache 30 is the only cache that implements proactive or reactive collection caching as described above. In one such embodiment, the request-agnostic cache 30 is closest cache to the data resource server 18. In still other embodiments, though, multiple different ones of the caches implement collection caching, across multiple different networks (i.e., not just in the service provider network 22). In this case, different proxy nodes 28 at different communicative distances from a given client device 12 have different sizes of caches 30 and/or different data staleness times.

In at least some embodiments, the proxy node 28 herein comprises an IPTV proxy in an IPTV system 10, such as a multi-screen IPTV system. Of course, those skilled in the art will appreciate that embodiments herein prove advantageous in many other contexts as well.

Moreover, in one or more embodiments, data resources 16 as used herein comprise public data, rather than private data. Public data in this case is capable of being freely shared by end-users and network nodes without security risk. Private data by contrast belongs specifically to an end-user and is not so freely shared.

Still further, the term “subset” is used herein in its general sense to refer to a part or portion of a larger set. This contrasts with the mathematical or technical sense of the term in which a subset may be the same as the set. In mathematical terms, a “subset” as used herein is really a “proper subset.”

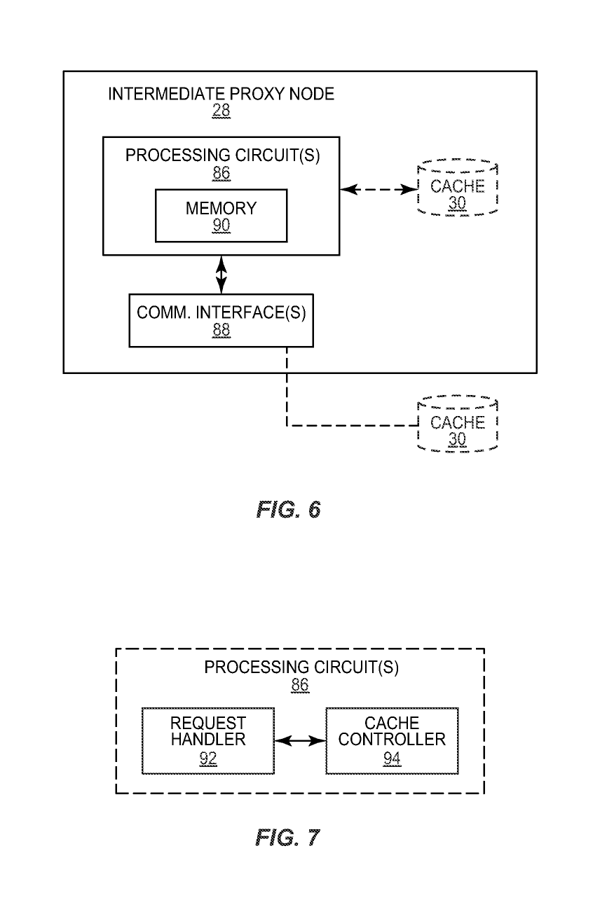

In view of the various modifications and alternatives discussed above, those skilled in the art will appreciate that FIG. 6 illustrates an apparatus configured to carry out the techniques described above. Specifically, FIG. 6 depicts an intermediate proxy node 28 configured to perform the method shown in either FIG. 2 or FIG. 4. The proxy node 28 includes one or more communication interfaces 88 and one or more processing circuits 86. The one or more communication interfaces 88 use known signal processing techniques, typically according to one or more communication standards, for communicatively coupling the node 28 to other network nodes in the service provider network 22 as well as nodes in other networks. That is, the one or more interfaces 88 are configured to format digital data and condition a communication signal, from that data, for transmission over a communications link.

The one or more processing circuits 86 are configured to extract digital data from the one or more interfaces 88 for processing, and to generate digital data for transmission over the one or more interfaces 88. More particularly, the one or more processing circuits 86 comprise one or several microprocessors, digital signal processors, and the like, as well as other digital hardware (not shown). The one or more processing circuits 86 also include memory 90. Memory 90, which may comprise one or several types of memory such as read-only memory (ROM), random-access memory, cache memory, flash memory devices, optical storage devices, etc., stores program code for executing one or more data communications protocols and for carrying out one or more of the techniques described herein. Memory 90 further stores program data for carrying out such techniques, and also stores various parameters and/or other program data for controlling the operation of the proxy node 28.

Of course, not all of the steps of the techniques described herein are necessarily performed in a single microprocessor or even in a single module. Thus, FIG. 7 presents a more generalized view of a proxy node 28 configured to carry out the methods shown in either FIG. 2 or FIG. 4. This proxy node 28 may have a physical configuration that corresponds directly to processing circuits 86, for example, or may be embodied in two or more modules or units. In either case, the proxy node 28 includes a request handler 92 and a cache controller 94. The request handler 92 is configured to perform steps in the methods described above related to receiving a request and returning a response to that request. The cache controller 94 is configured to perform steps in the methods related to determining whether resources 16 are stored in the cache 30, retrieving resources 16 from the cache 30, and storing resources 16 in the cache 30.

Those skilled in the art will of course recognize that the present invention may be carried out in other ways than those specifically set forth herein without departing from essential characteristics of the invention. The present embodiments are thus to be considered in all respects as illustrative and not restrictive, and all changes coming within the meaning and equivalency range of the appended claims are intended to be embraced therein.

What is claimed is:

1. A method implemented by an intermediate proxy node via which client devices request data resources from a data resource server, the data resources organized into different data resource collections, comprising:
receiving a request for a subset of a data resource collection;
responsive to receiving the request, determining that the data resource collection is not stored in a request-agnostic cache maintained by the intermediate proxy node;
responsive to said determination, retrieving the data resource collection from the data resource server;
extracting the requested subset from the retrieved data resource collection and selectively returning that subset as a response to the request; and
storing the data resource collection in the request-agnostic cache for serving other requests for data resources in the data resource collection, including a request for a different subset of the data resource collection.

2. The method of claim 1, further comprising:
receiving a different request for a different subset of the data resource collection;
responsive to receiving the different request, extracting the different subset from the data resource collection stored in the request-agnostic cache; and
selectively returning the different subset extracted from the data resource collection as a response to the different request.

3. The method of claim 2, wherein the request and the different request are received from different types of client devices with at least one of different display, memory, and processing capabilities.

4. The method of claim 1, wherein receiving the request for the subset comprises receiving a request for the data resource collection in conjunction with one or more constraining parameters that constrain a response to the request to the subset, and wherein retrieving the data resource collection from the data resource server comprises sending the request for the data resource collection without the one or more constraining parameters towards the data resource server.

5. The method of claim 4, wherein selectively returning the subset of the data resource collection as a response to the request comprises:
processing the data resource collection received from the data resource server according to the one or more constraining parameters in order to extract the subset from the data resource collection; and
returning the extracted subset as the response to the request.

6. The method of claim 1, wherein the request comprises an HTTP request.

7. An intermediate proxy node via which client devices request data resources from a data resource server, the data resources organized into different data resource collections, comprising:
one or more communication interfaces configured to communicatively couple the intermediate proxy node to a client device and the data resource server; and
one or more processing circuits configured to:
receiving, via the one or more communication interfaces, a request for a subset of a data resource collection;
responsive to receiving the request, determine that the data resource collection is not stored in a request-agnostic cache maintained by the intermediate proxy node;
responsive to said determination, retrieving the data resource collection from the data resource server;
extract the requested subset from the retrieved data resource collection and selectively return that subset, via the one or more communication interfaces, as a response to the request; and
store the data resource collection in the request-agnostic cache for serving other requests for data resources in the data resource collection, including a request for a different subset of the data resource collection.

8. The intermediate proxy node of claim 7, wherein the one or more processing circuits are further configured to:
receive, via the one or more communication interfaces, a different request for a different subset of the data resource collection;
responsive to receiving the different request, extract the different subset from the data resource collection stored in the request-agnostic cache; and
selectively return, via the one or more communication interfaces, the different subset extracted from the data resource collection as a response to the different request.

9. The intermediate proxy node of claim 8, wherein the request and the different request are received from different types of client devices with at least one of different display, memory, and processing capabilities.

10. The intermediate proxy node of claim 7, wherein the one or more processing circuits are configured to receive the request for the subset as a request for the data collection in conjunction with one or more constraining parameters that constrain a response to the request to the subset, and are configured to retrieve the data resource collection from the data resource server by sending, via the one or more communication interfaces, the request for the data collection without the one or more constraining parameters towards the data resource server.

11. The intermediate proxy node of claim 10, wherein the one or more processing circuits are configured to selectively return the subset of the data resource collection as a response to the request by:
processing the data resource collection received from the data resource server according to the one or more constraining parameters in order to extract the subset from the data resource collection; and
returning the extracted subset as the response to the request.

12. The intermediate proxy node of claim 7, wherein the request comprises an HTTP request.

13. A method implemented by an intermediate proxy node via which client devices request data resources from a data resource server, the data resources organized into different data resource collections, comprising:
receiving a request for a subset of a data resource collection;
identifying a first part of the requested subset as being stored in a request-agnostic cache maintained by the intermediate proxy node and a second part of the requested subset as not being stored in the request-agnostic cache;
retrieving the first part of the requested subset from the request-agnostic cache and the second part of the requested subset from the data resource server; and
returning the requested subset as formed from the first and second parts retrieved.

14. The method of claim 13, further comprising storing the second part of the requested subset in the request-agnostic cache for serving other requests for data resources in the data resource collection, including a request for a different subset of the data resource collection.

15. The method of claim 13, wherein receiving the request for the subset comprises receiving a request for the data collection in conjunction with one or more constraining parameters that constrain a response to the request to the subset, and wherein retrieving the second part of the requested subset from the data resource server comprises selectively sending the request for the data resource collection towards the data resource server with those of the constraining parameters that are to constrain a response to the second part of the subset, but without any of the constraining parameters that are to constrain a response to the first part of the subset.

16. The method of claim 13, wherein, before the request for the subset is received, the first part of the subset is retrieved from the data resource server and stored in the request-agnostic cache in response to one or more requests for one or more different subsets.

17. The method of claim 13, wherein the request comprises an HTTP request.

18. An intermediate proxy node via which client devices request data resources from a data resource server, the data resources organized into different data resource collections, comprising:
one or more communication interfaces configured to communicatively couple the intermediate proxy node to a client device and the data resource server; and
one or more processing circuits configured to:
receive, via the one or more communication interfaces, a request for a subset of a data resource collection;
identify a first part of the requested subset as being stored in a request-agnostic cache maintained by the intermediate proxy node and a second part of the requested subset as not being stored in the request-agnostic cache;
retrieve the first part of the requested subset from the request-agnostic cache and the second part of the requested subset from the data resource server; and
return, via the one or more communication interfaces, the requested subset as formed from the first and second parts retrieved.

19. The intermediate proxy node of claim 18, wherein the one or more processing circuits are further configured to store the second part of the requested subset in the request-agnostic cache for serving other requests for data resources in the data resource collection, including a request for a different subset of the data resource collection.

20. The intermediate proxy node of claim 18, wherein the one or more processing circuits are configured to receive the request for the subset by receiving a request for the data collection in conjunction with one or more constraining parameters that constrain a response to the request to the subset, and to retrieve the second part of the requested subset from the data resource server by selectively sending the request for the data collection towards the data resource server with those of the constraining parameters that are to constrain a response to the second part of the subset, but without any of the constraining parameters that are to constrain a response to the first part of the subset.

21. The intermediate proxy node of claim 18, wherein, before the request for the subset is received, the first part of the subset is retrieved from the data resource server and stored in the request-agnostic cache in response to one or more requests for one or more different subsets.

22. The intermediate proxy node of claim 18, wherein the request comprises an HTTP request.
